(19) United States
(12) Patent Application Publication
(10) Pub. No.: US 2024/0249268 A1
(43) Pub. Date: Jul. 25, 2024

(54) POINT-OF-SALE SYSTEM, METHOD PERFORMED THEREBY, AND USER TERMINAL

(71) Applicant: Toshiba Tec Kabushiki Kaisha, Tokyo (JP)

(72) Inventor: Yuki MATSUMOTO, Tagata Shizuoka (JP)

(21) Appl. No.: 18/508,089

(22) Filed: Nov. 13, 2023

(30) Foreign Application Priority Data
Jan. 19, 2023 (JP) 2023-006660

(51) Int. Cl. G06Q 20/20; G06Q 20/32

(52) U.S. Cl. CPC G06Q 20/208; G06Q 20/209; G06Q 20/3274

(57) ABSTRACT

A point-of-sale (POS) system includes a user terminal configured to generate and display a symbol that represents a payment code that can be used for payment in a sales transaction and a setting related to issuance of a receipt; and a POS terminal including a scanner, a printer, and a processor configured to: register one or more items for purchase, decode a symbol read by the scanner to obtain a payment code and a setting, execute payment processing for the items that have been registered for purchase using the payment code obtained by decoding the symbol, after the payment processing is executed, determine whether to issue a receipt based on the setting obtained by decoding the symbol, and upon determining to issue a receipt, control the printer to issue a receipt for the purchased items.

### CROSS-REFERENCE TO RELATED APPLICATION

This application is based upon and claims the benefit of priority from Japanese Patent Application No. 2023-006660, filed Jan. 19, 2023, the entire contents of which are incorporated herein by reference.

### FIELD

An aspect of the present disclosure relates to a point-of-sale (POS) system, a method performed thereby, and a user terminal.

### BACKGROUND

There are customers who require receipts for transactions and customers who do not require receipts for transactions. For this reason, a known transaction processing device has a function that enables a store clerk to select whether to issue a receipt.

However, this approach requires the store clerk to ask a customer whether the customer needs a receipt and is therefore troublesome for both the store clerk and the customer. Thus, it is desirable to easily and flexibly perform a process such as receipt issuance depending on the requirements of the customer.

### SUMMARY OF THE INVENTION

One aspect of the present disclosure provides a payment system, a terminal device, and a storage medium that make it possible to easily and flexibly perform a process, which is performed in connection with payment but is not the payment itself, according to the needs of a payer.

An aspect of the present disclosure provides a POS system comprising: a user terminal configured to generate and display a symbol that represents a payment code that can be used for payment in a sales transaction and a setting related to issuance of a receipt; and a POS terminal including a scanner, a printer, and a processor configured to: register one or more items for purchase, decode a symbol read by the scanner to obtain a payment code and a setting, execute payment processing for the items that have been registered for purchase using the payment code obtained by decoding the symbol, after the payment processing is executed, determine whether to issue a receipt based on the setting obtained by decoding the symbol, and upon determining to issue a receipt, control the printer to issue a receipt for the purchased items.

### BRIEF DESCRIPTION OF THE DRAWINGS

FIG. 1 is a block diagram illustrating a configuration of a transaction processing system according to an embodiment.

FIG. 2 is a hardware block diagram of a point-of-sale (POS) terminal in FIG. 1.

FIG. 3 is a hardware block diagram of a user terminal in FIG. 1.

FIG. 4 is a diagram illustrating a data structure of setting data in FIG. 3.

FIG. 5 is a flowchart illustrating a transaction process.

FIG. 6 is a flowchart illustrating a code payment process.

FIG. 7 is a flowchart illustrating a code payment process.

FIG. 8 is a diagram illustrating an example of a top screen.

FIG. 9 is a diagram illustrating an example of a setting screen.

FIG. 10 is a diagram illustrating an example of a bar code screen.

### DETAILED DESCRIPTION

Hereinafter, embodiments will be described in detail with reference to the drawings. The present invention is not limited to the embodiments described below.

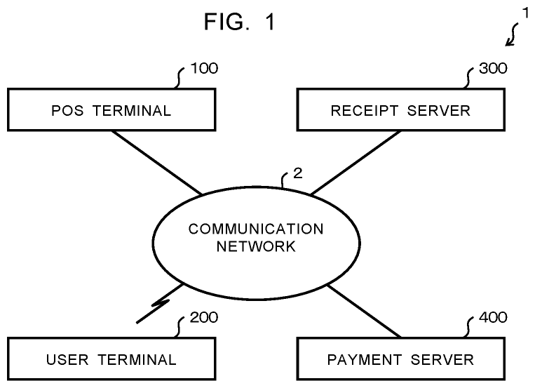

FIG. 1 is a block diagram illustrating a configuration of a transaction processing system 1 according to an embodiment.

The transaction processing system 1 is for processing transactions related to the purchase and sale of items between customers and stores. As a part of a transaction process, the transaction processing system 1 performs a process for making a payment for the transaction. Thus, the transaction processing system 1 also functions as a payment system.

The transaction processing system 1 includes a POS terminal 100, a user terminal 200, a receipt server 300, and a payment server 400 that can communicate with each other via a communication network 2. For example, the communication network 2 may include one or more of the Internet, a virtual private network (VPN), a local area network (LAN), a public telecommunications network, and a mobile communication network. For example, the communication network 2 includes the Internet and a mobile communication network. Although only one POS terminal 100 and one user terminal 200 are illustrated in FIG. 1, the transaction processing system 1 may include any number of POS terminals 100 and user terminals 200.

The POS terminal 100 performs information processing for processing a transaction according to an operation performed by an operator at a store. The POS terminal 100 may be a face-to-face type that is mainly operated by a store clerk, a full self-service type that is mainly operated by a customer, or a semi self-service type that is operated by a store clerk and a customer.

The user terminal 200 is an information processing terminal held by a customer. Typically, the user terminal 200 is owned by a customer and is brought into a store and used by the customer. Alternatively, the user terminal 200 may be an information communication terminal lent by a store to a customer or an information communication terminal attached to a shopping cart that is provided as equipment of a store.

The receipt server 300 performs information processing to provide an electronic receipt service for enabling a customer to view an electronic receipt that electronically represents a result of a transaction at a store. The receipt server 300 also performs information processing for enabling a user of the electronic receipt service to use a code payment service provided by the payment server 400.

The payment server 400 performs information processing for making a payment for a transaction processed by the POS terminal 100 by, for example, credit card payment, electronic money payment, or code payment. One or both of the receipt server 300 and the payment server 400 may be constituted by one computer device or multiple computer devices.

Typically, the POS terminal 100, the receipt server 300, and the payment server 400 are operated by different independent entities. For example, the POS terminal 100 may be operated by a retailer, the receipt server 300 may be operated by an electronic receipt service provider, and the payment server 400 may be operated by a payment service provider. However, two or all of the POS terminal 100, the receipt server 300, and the payment server 400 may be operated by the same entity.

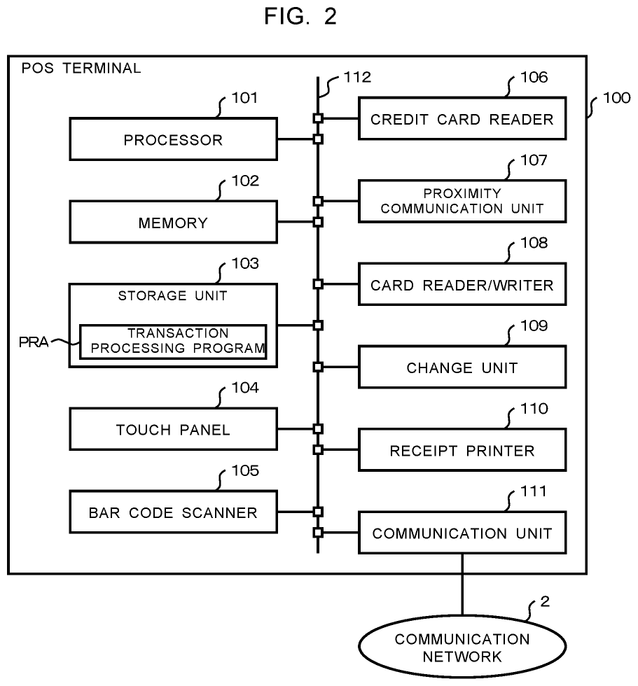

FIG. 2 is a hardware block diagram of the POS terminal 100.

The POS terminal 100 includes a processor 101, a memory 102, a storage unit 103, a touch panel 104, a bar code scanner 105, a credit card reader 106, a proximity communication unit 107, a card reader/writer 108, a change unit 109, a receipt printer 110, a communication unit 111, and a bus 112. The processor 101, the memory 102, the storage unit 103, the touch panel 104, the bar code scanner 105, the credit card reader 106, the proximity communication unit 107, the card reader/writer 108, the change unit 109, the receipt printer 110, and the communication unit 111 are connected to the bus 112.

The processor 101, the memory 102, and the storage unit 103 are connected to each other via the bus 112 to form a controller that performs information processing related to the control of the POS terminal 100.

The processor 101 corresponds to a core component of the controller. The processor 101 performs information processing according to a program, such as an operating system and an application program, to control components of the POS terminal 100 and thereby performs various functions of the POS terminal 100.

The memory 102 includes a read-only memory area and a rewritable memory area. The read-only memory area of the memory 102 stores one or more programs. The read-only memory area or the rewritable memory area of the memory 102 may also store data necessary for the processor 101 to perform processes for controlling the components of the POS terminal 100. The rewritable memory area of the memory 102 is also used as a work area for the processor 101.

The storage unit 103 includes, for example, an electrically erasable programmable read-only memory (EEPROM), a hard disk drive (HDD), a solid state drive (SSD), or any other known storage device. The storage unit 103 stores data used by the processor 101 to perform various processes and data generated as a result of processes performed by the processor 101. The storage unit 103 may also store one or more programs. In an embodiment, the storage unit 103 stores a transaction processing program PRA for executing a transaction process described later.

The touch panel 104 displays screens for providing information to an operator. The touch panel 104 also receives instructions input by an operator by touching a screen.

The bar code scanner 105 optically reads a bar code placed over a reader.

The bar code scanner 105 outputs bar code information represented by the read bar code.

The credit card reader 106 reads card information from a credit card.

The proximity communication unit 107 performs proximity wireless communication with a nearby wireless tag and obtains data stored in the wireless tag. Also, the proximity communication unit 107 writes information to the wireless tag via proximity wireless communication.

The card reader/writer 108 reads card data recorded in a card such as a member card or a prepaid card. Also, the card reader/writer 108 writes data to a member card.

At least two of the bar code scanner 105, the credit card reader 106, the proximity communication unit 107, and the card reader/writer 108 may be integrated into a single device. For example, one card reader having the functions of both of the credit card reader 106 and the card reader/writer 108 may be used.

The bar code scanner 105, the credit card reader 106, the proximity communication unit 107, and the card reader/writer 108 may not be integrated into the POS terminal 100 and may be attached to the POS terminal 100. For example, an external payment terminal attached to the POS terminal 100 may perform at least one of the functions of the bar code scanner 105, the credit card reader 106, the proximity communication unit 107, and the card reader/writer 108.

The change unit 109 counts the amount of coins dropped into a coin slot and stores the coins in its internal storage. Also, the change unit 109 dispenses coins stored in the storage to a coin tray via a coin dispensing slot. Also, the change unit 109 counts the amount of bills inserted into a bill slot and stores the bills in its internal storage. The change unit 109 dispenses bills stored in the storage via a bill dispensing slot. The bill dispensing slot holds the dispensed bills in such a manner that parts of the bills are exposed.

The receipt printer 110 prints an image on a receipt sheet under the control of the processor 101. The receipt printer 110 may be any known printing device such as a thermal printer.

The communication unit 111 is a network interface circuit that performs a communication process for enabling the POS terminal 100 to transmit and receive various types of data to and from other devices, such the receipt server 300 and the payment server 400, via the communication network 2. The communication unit 111 may be any known device that supports the communication method of the communication network 2.

The bus 112 includes an address bus, a data bus, and a control signal line. The bus 112 transmits data and signals that are exchanged between components connected via the bus 112.

For example, hardware of an existing POS terminal may be used as part of the hardware of the POS terminal 100, and the POS terminal 100 is generally supplied in a state where the transaction processing program PRA is stored in the storage unit 103. However, the hardware of the POS terminal 100, in which the transaction processing program PRA has not been stored in the storage unit 103, and the transaction processing program PRA may be supplied separately. In this case, the transaction processing program PRA may be installed in the storage unit 103 according to an operation by an operator. Alternatively, the hardware of the POS terminal 100 in a state where a transaction processing program, which is the same type as and a different version of the transaction processing program PRA, is stored in the storage unit 103 and the transaction processing program PRA may be separately supplied. In this case, the transaction processing program already stored in the storage unit 103 may be overwritten by the transaction processing program PRA. The transaction processing program PRA may be stored in and supplied via a non-transitory computer-readable storage medium, such as a magnetic disk, a magneto-optical disk, an optical disk, or a semiconductor memory, or may be supplied by communication via a network. The transaction processing program PRA may instead be stored in the memory 102.

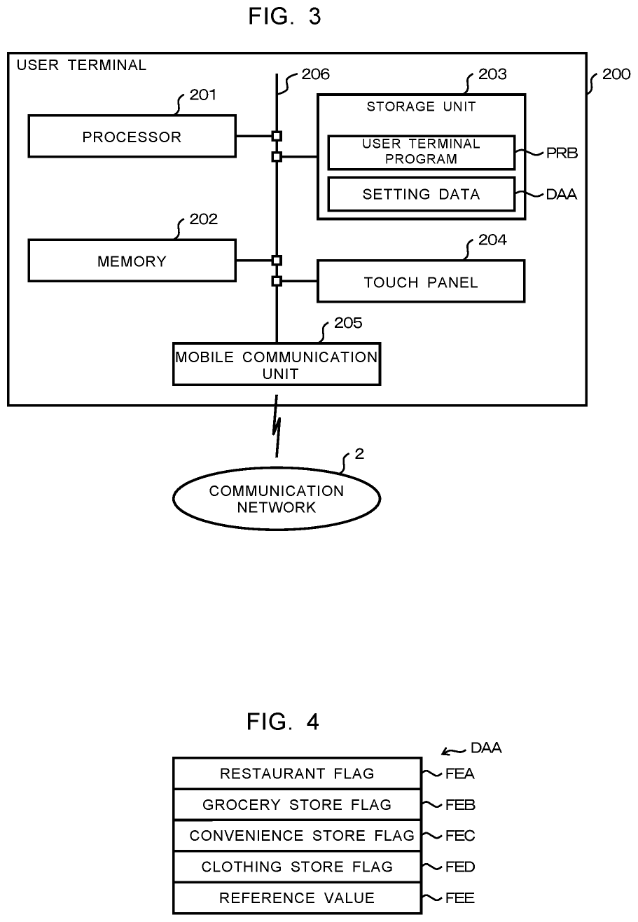

FIG. 3 is a hardware block diagram of the user terminal 200.

The user terminal 200 includes a processor 201, a memory 202, a storage unit 203, a touch panel 204, a mobile communication unit 205, and a bus 206.

The basic functions of the processor 201, the memory 202, the storage unit 203, the touch panel 204, and the bus 206 are substantially the same as those of the processor 101, the memory 102, the storage unit 103, the touch panel 104, and the bus 112, and their descriptions are omitted here. However, the storage unit 203 stores a user terminal program PRB instead of the transaction processing program PRA. The user terminal program PRB is an application program executed by the processor 201 to cause the user terminal 200 to function as a user interface for using an electronic receipt service provided by the receipt server 300. The storage unit 203 also stores setting data DAA. The setting data DAA is described later.

The mobile communication unit 205 is an interface circuit for data communication via the communication network 2. The mobile communication unit 205 may be implemented by a known communication device used for data communication via, for example, a mobile communication network.

The hardware of the user terminal 200 may include, for example, hardware used for a smartphone or a tablet computer.

The setting data DAA is used to manage user settings related to receipt issuance performed when code payment, which is described later, is used.

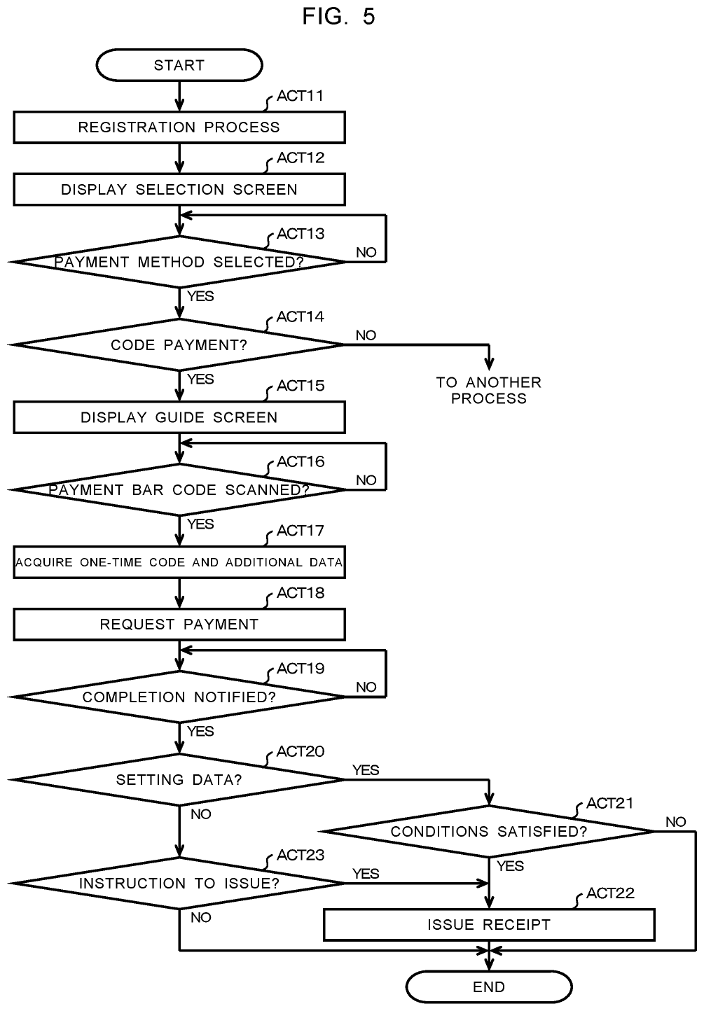

FIG. 4 illustrates a data structure of the setting data DAA.

The setting data DAA includes five fields FEA, FEB, FEC, FED, and FEE. The field FEA contains a flag (hereafter referred to as a restaurant flag) that indicates whether to issue a receipt when the category of a store, where a transaction is performed, is “restaurant”. The field FEB contains a flag (hereafter referred to as a grocery store flag) that indicates whether to issue a receipt when the category of a store, where a transaction is performed, is “grocery store”. The field FEC contains a flag (hereafter referred to as a convenience store flag) that indicates whether to issue a receipt when the category of a store, where a transaction is performed, is “convenience store”. The field FED contains a flag (hereafter referred to as a clothing store flag) that indicates whether to issue a receipt when the category of a store, where a transaction is performed, is “clothing store”. The field FEE contains a reference value that is used as a threshold to determine whether to issue a receipt based on the number of items in a transaction.

Operations of the transaction processing system 1 configured as explained above are described below. Various processes described below are examples, and it is possible to change the order of some processes, omit some processes, and/or add other processes as necessary. For example, in the descriptions below, some processes are omitted to facilitate the understanding of characteristic operations of the present embodiment. For example, when an error occurs, a process to deal with the error may be performed. However, descriptions of such a process are omitted here.

When purchasing items at a store where the POS terminal 100 is installed, a customer picks up the items to be purchased on the sales floor, brings the items to a checkout area, and pass the items to a store clerk who operates the POS terminal 100. The store clerk starts a predetermined operation on the POS terminal 100 to register the items received from the customer as transaction targets.

Alternatively, the customer starts a predetermined operation on the POS terminal 100 to register the items to be purchased as transaction targets. In response, the processor 101 of the POS terminal 100 starts a transaction process according to the transaction processing program PRA.

FIG. 5 is a flowchart illustrating a transaction process.

At ACT 11, the processor 101 performs a registration process. In the registration process, items are registered as transaction targets in response to an operation performed by the store clerk or the customer. The registration process may be similar to a process performed by an existing POS terminal device.

When completing the registration of all items as transaction targets, the store clerk or the customer performs a predetermined operation to instruct the start of a payment process. In response, the processor 101 ends the registration process and proceeds to ACT 12.

At ACT 12, the processor 101 controls the touch panel 104 to display a selection screen. The selection screen enables the store clerk or the customer to select a payment method to be used for the payment for a transaction being processed. For example, the selection screen displays software keys each of which is used to select one of available payment methods. Examples of available payment methods include cash payment, credit card payment, prepaid card payment, electronic money payment, and code payment. Also, the selection screen may enable a selection of a payment service from multiple payment services available for each payment method.

At ACT 13, the processor 101 waits until a payment method is selected.

The customer or the store clerk, who has heard a request from the customer, selects a payment method by performing a predetermined operation such as tapping a software key associated with the payment method to be used. In response, the processor 101 determines that a payment method has been selected (YES at ACT 13) and proceeds to ACT 14.

At ACT 14, the processor 101 determines whether the selected payment method is code payment. When a payment method other than code payment has been selected, the processor 101 proceeds to another process to determine the selected payment method and make a payment with the selected payment method. In an example of the other process, the processor 101 determines that credit payment has been selected and then performs credit payment using the credit card reader 106. In another example of the other process, the processor 101 determines that electronic money payment has been selected and then performs electronic money payment using the proximity communication unit 107. In another example of the other process, the processor 101 determines that prepaid card payment has been selected and then performs prepaid card payment using the card reader/writer 108. In another example of the other process, the processor 101 determines that cash payment has been selected and then performs cash payment using the change unit 109. These examples of other processes may be similar to those performed by an existing POS terminal device, and therefore the illustration and descriptions of these processes are omitted.

When making a code payment, the customer starts a process performed by the user terminal program PRB at the user terminal 200 and then enters an instruction to activate a code payment function by performing a predetermined operation. In response to the instruction, the processor 201 of the user terminal 200 starts a code payment process as a part of the process performed by the user terminal program PRB.

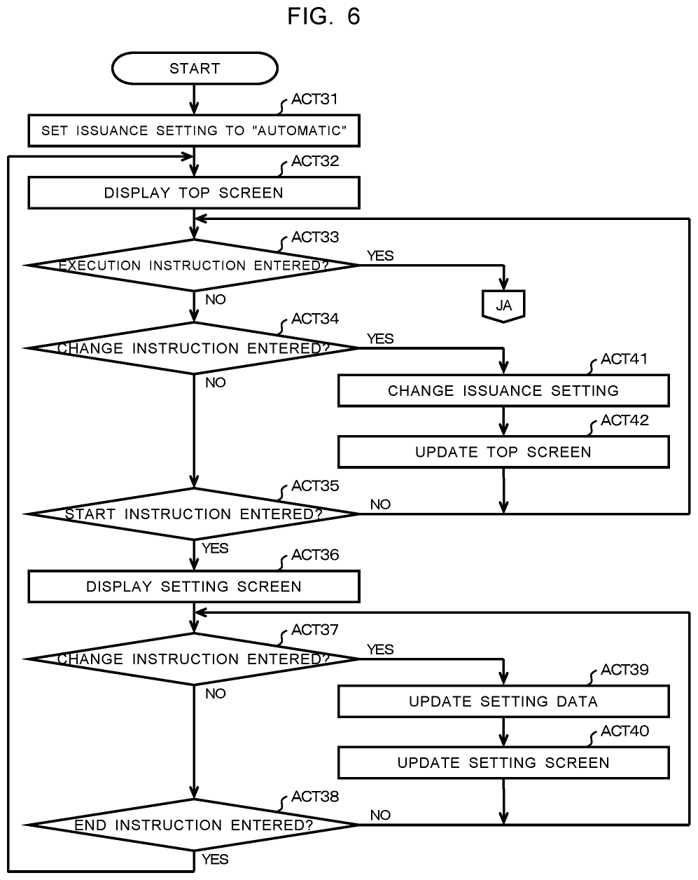

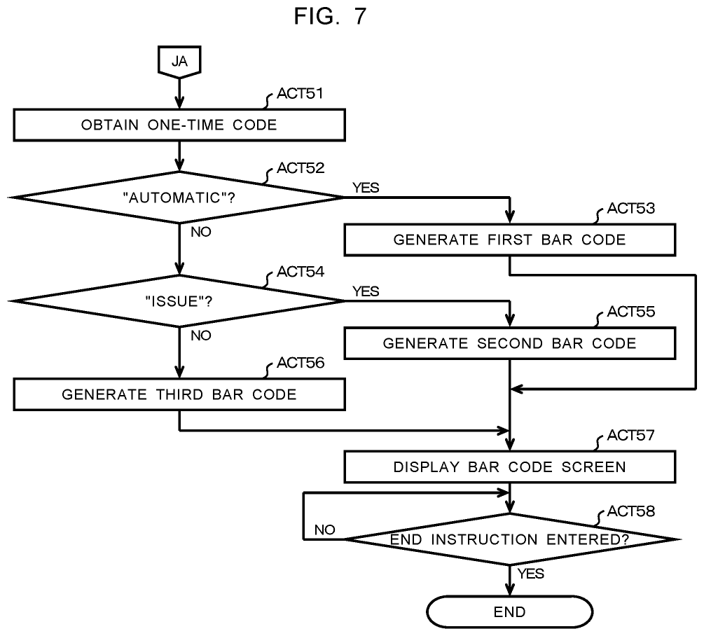

FIGS. 6 and 7 are flowcharts illustrating the code payment process.

At ACT 31 in FIG. 6, the processor 201 sets the initial value of a setting (hereafter referred to as an issuance setting) related to receipt issuance to “automatic”.

At ACT 32, the processor 201 controls the touch panel 204 to display a top screen. The top screen is a graphical user interface (GUI) screen used for operations performed to start code payment.

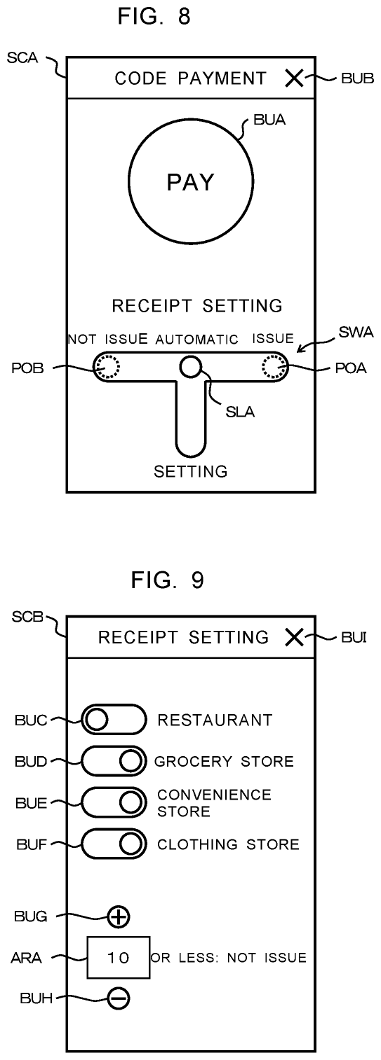

FIG. 8 illustrates an example of a top screen SCA.

In each of examples of screens illustrated in FIG. 8 and other drawings, some of display objects may be omitted.

The top screen SCA displays buttons BUA and BUB and a switch SWA as GUI objects.

The button BUA is a software key for receiving an instruction to perform code payment. The button BUB is a software key for receiving an instruction to cancel code payment. The switch SWA is a virtual switch that receives a swiping operation to slide a slider SLA as an instruction to change the issuance setting. The initial position of the slider SLA of the switch SWA is indicated by a solid line. The switch SWA also functions as an indicator indicating that the issuance setting is “automatic”.

At ACT 33 in FIG. 6, the processor 201 determines whether an instruction (hereafter referred to as an execution instruction) to perform code payment has been entered. When the execution instruction has not been entered (NO at ACT 33), the processor 201 proceeds to ACT 34.

At ACT 34, the processor 201 determines whether an instruction (hereafter referred to as a change instruction) to change the issuance setting has been entered. When the change instruction to change the issuance setting has not been entered (NO at ACT 34), the processor 201 proceeds to ACT 35.

At ACT 35, the processor 201 determines whether an instruction (hereafter referred to as a start instruction) to start the setting of conditions (hereafter referred to as issuance conditions) for automatically determining whether to issue receipts has been entered. When the start instruction to start the setting of the issuance conditions has not been entered (NO at ACT 35), the processor 201 returns to ACT 33.

Thus, at ACT 33 through ACT 35, the processor 201 waits until any of the instructions to perform code payment, to change the issuance setting, and to start the setting of the issuance conditions is entered.

When changing the issuance conditions, the customer performs a predetermined operation to give an instruction to start the setting. For example, the customer performs a swiping operation to slide the slider SLA downward on the top screen SCA in FIG. 8. In response, the processor 201 determines that the instruction to start the setting has been entered (YES at ACT 35 in FIG. 6) and proceeds to ACT 36.

At ACT 36, the processor 201 controls the touch panel 204 to display a setting screen. The setting screen is a GUI screen for receiving instructions to change the issuance conditions.

FIG. 9 illustrates an example of a setting screen SCB.

The setting screen SCB displays buttons BUC, BUD, BUE, BUF, BUG, BUH, and BUI as GUI objects. The setting screen SCB also includes a display area ARA. The buttons BUC through BUF are associated with categories “restaurant”, “grocery store”, “convenience store”, and “clothing store”, respectively. Each of the buttons BUC through BUF is a toggle button that indicates whether to issue a receipt for a transaction performed at a store belonging to the corresponding category and is also used to change the setting. In the example of the setting screen SCB illustrated in FIG. 9, the issuance conditions are set such that no receipt is issued for a transaction at a store belonging to the category “restaurant” and receipts are issued for transactions at stores belonging to the categories “grocery store”, “convenience store”, and “clothing store”. When the setting screen SCB is displayed at ACT 36, the processor 201 determines the display states of the buttons BUC through BUF according to the flags set in the fields FEA through FED of the setting data DAA.

The button BUG is a software key for receiving an instruction to increase a reference value displayed in the display area ARA. The button BUH is a software key for receiving an instruction to decrease the reference value displayed in the display area ARA. When the setting screen SCB is displayed at ACT 36, the processor 201 controls the touch panel 204 to display, in the display area ARA, a value that is set in the field FEE of the setting data DAA and indicates the reference value.

The button BUI is a software key for receiving an instruction to end the operation to change the issuance conditions.

After the setting screen SCB is displayed at ACT 36 in FIG. 6, the processor 201 proceeds to ACT 37.

At ACT 37, the processor 201 determines whether a change instruction has been entered. When the change instruction has not been entered (NO at ACT 37), the processor 201 proceeds to ACT 38.

At ACT 38, the processor 201 determines whether an end instruction has been entered. When the end instruction has not been entered (NO at ACT 38), the processor 201 returns to ACT 37.

Thus, the processor 201 waits for the change instruction or the end instruction at ACT 37 and ACT 38.

To change an issuance condition, the customer performs a predetermined operation. For example, when the setting screen SCB is in a state as illustrated in FIG. 9 and the customer does not want to issue a receipt for a transaction at a store belonging to the category “clothing store”, the customer taps the button BUF. As another example, when the setting screen SCB is in a state as illustrated in FIG. 9 and the customer wants to set the reference value to “12”, the customer taps the button BUG twice.

When it is determined that an operation to enter a change instruction has been performed (YES at ACT 37), the processor 201 proceeds to ACT 39.

At ACT 39, the processor 201 updates the setting data DAA according to the change instruction. For example, when the button BUF is tapped, the processor 201 reverses the state of the flag set in the field FED of the setting data DAA. For example, each time the button BUG is tapped, the processor 201 increases the value set in the field FEE of the setting data DAA by one.

At ACT 40, the processor 201 updates the setting screen SCB to reflect the updated setting data DAA. For example, when the state of the flag set in the field FED of the setting data DAA is reversed, the processor 201 changes the display state of the button BUF. As another example, when the value set in the field FEE of the setting data DAA is changed, the processor 201 replaces the value displayed in the display area ARA with the changed value.

Then, the processor 201 returns to a standby state in ACT 37 and ACT 38. Thus, the processor 201 repeats ACT 39 and ACT 40 each time a change instruction is made.

After changing the issuance conditions, the customer enters an end instruction by performing a predetermined operation such as tapping the button BUI. In response, the processor 201 determines that an end instruction has been entered (YES at ACT 38), returns to ACT 32, and repeats ACT 32 and the subsequent steps as described above.

To change the issuance setting, the customer performs a predetermined operation. For example, when the customer wants to issue a receipt for any payment to be made regardless of the issuance conditions, the customer performs a swiping operation on the top screen SCA to move the slider SLA to a position POA indicated by a dotted line. As another example, when the customer does not want to issue a receipt for any payment to be made regardless of the issuance conditions, the customer performs a swiping operation on the top screen SCA to move the slider SLA to a position POB indicated by a dotted line. As still another example, when the issuance setting is set to unconditionally issue a receipt or unconditionally not issue a receipt and the customer wants to set the issuance setting to “automatic”, the customer performs a swiping operation to move the slider SLA to the position indicated by a solid line in FIG. 8.

When determining that a change instruction to change the issuance setting has been entered (YES at ACT 34 in FIG. 6), the processor 201 proceeds to ACT 41.

As ACT 41, the processor 201 changes the issuance setting according to the change instruction. For example, when a swiping operation to move the slider SLA to the position POA is performed, the processor 201 changes the issuance setting to “issue”. As another example, when a swiping operation to move the slider SLA to the position POB is performed, the processor 201 changes the issuance setting to “not issue”. As still another example, when a swiping operation to move the slider SLA to the position indicated by a solid line in FIG. 8 is performed, the processor 201 changes the issuance setting to “automatic”. The processor 201 stores data indicating that the issuance setting is set to “automatic”, “issue”, or “not issue” in the memory 202 or the storage unit 203.

At ACT 42, the processor 201 updates the top screen SCA according to the changed issuance setting. For example, when the issuance setting is changed to “issue”, the processor 201 updates the top screen SCA such that the slider SLA is displayed at the position POA. As another example, when the issuance setting is changed to “not issue”, the processor 201 updates the top screen SCA such that the slider SLA is displayed at the position POB. As still another example, when the issuance setting is changed to “automatic”, the processor 201 restores the top screen SCA illustrated in FIG. 8.

Then, the processor 201 returns to a standby state in ACT 33 through ACT 35.

When determining to proceed to payment, the customer performs a predetermined operation such as tapping the button BUA on the top screen SCA to enter an instruction to make a payment. When determining that an instruction to make a payment has been entered (YES at ACT 33 in FIG. 6), the processor 201 proceeds to ACT 51 in FIG. 7. At ACT 51, the processor 201 obtains a one-time code as an authentication code used for authentication for code payment. For example, the processor 201 requests a one-time code from the receipt server 300. For example, the processor 201 controls the mobile communication unit 205 to transmit predetermined request data for requesting a one-time code via the communication network 2 to the receipt server 300. When the request data is transmitted via the communication network 2 to the receipt server 300, the receipt server 300 requests a one-time code from the payment server 400. In response to the request, the payment server 400 generates a one-time code. The one-time code may be similar to a code used in an existing code payment system. The payment server 400 transmits the generated one-time code to the receipt server 300 as a response to the request. When receiving the one-time code from the payment server 400, the receipt server 300 transmits the received one-time code via the communication network 2 to the user terminal 200 as a response to the request from the user terminal 200. When the one-time code is transmitted from the receipt server 300 via the communication network 2 to the user terminal 200 and received by the mobile communication unit 205 of the user terminal 200, the processor 201 stores the received one-time code in the memory 202 or the storage unit 203. The process of obtaining a one-time code may be similar to an existing process performed for code payment.

At ACT 52, the processor 201 determines whether the issuance setting is “automatic”. When determining that the issuance setting is “automatic” (YES at ACT 52), the processor 201 proceeds to ACT 53.

At ACT 53, the processor 201 generates a first bar code. For example, the processor 201 generates the first bar code that represents bar code data including the setting data DAA as additional data together with the one-time code obtained at ACT 51. In this case, the processor 201 reads the setting data DAA stored in the storage unit 203 and thereby obtains settings made by the payer.

When determining that the issuance setting is not “automatic” (NO at ACT 52), the processor 201 proceeds to ACT 54.

At ACT 54, the processor 201 determines whether the issuance setting is “issue”. When determining that the issuance setting is “issue” (YES at ACT 54), the processor 201 proceeds to ACT 55.

At ACT 55, the processor 201 generates a second bar code. For example, the processor 201 generates the second bar code representing bar code data that includes, as additional data, predetermined instruction data for instructing issuance of receipts together with the one-time code obtained at ACT 51. Here, because the processor 201 has acquired an instruction to set the issuance setting to “issue”, it can be said that the processor 201 has obtained a setting made by the payer.

When determining that the issuance setting is “not issue” (NO at ACT 54), the processor 201 proceeds to ACT 56.

At ACT 56, the processor 201 generates a third bar code. For example, the processor 201 generates the third bar code representing bar code data that includes, as additional data, predetermined instruction data for making an instruction not to issue a receipt together with the one-time code obtained at ACT 51. Here, because the processor 201 has acquired an instruction to set the issuance setting to “not issue”, it can be said that the processor 201 has obtained a setting made by the payer.

When completing any one of ACT 53, ACT 55, and ACT 56, the processor 201 proceeds to ACT 57.

At ACT 57, the processor 201 controls the touch panel 204 to display a bar code screen. The bar code screen displays the first bar code, the second bar code, or the third bar code generated at ACT 53, ACT 55, or ACT 56 as a payment bar code.

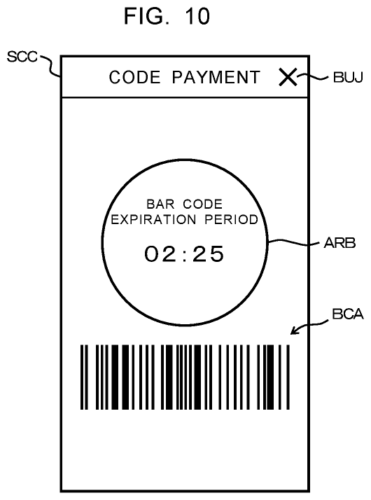

FIG. 10 illustrates an example of a bar code screen SCC.

The bar code screen SCC displays a payment bar code BCA and a button BUJ. The bar code screen SCC also includes a display area ARB.

The payment bar code BCA is the first bar code, the second bar code, or the third bar code generated at ACT 53, ACT 55, or ACT 56. The button BUJ is a software key for receiving an instruction to close the bar code screen SCC. The processor 201 causes the touch panel 204 to display an expiration period of the one-time code obtained at ACT 51 in the display area ARB. While the bar code screen SCC is being displayed, the processor 201 updates the display area ARA to gradually decrease the expiration period.

The payment bar code BCA is not limited to a one-dimensional bar code as illustrated in FIG. 10 but may also be a different type of code, such as a two-dimensional code.

With reference back to FIG. 5, at the POS terminal 100, the store clerk or the customer selects code payment by performing a predetermined operation, such as tapping, through a software key associated with code payment. In response, the processor 101 determines that code payment has been selected (YES at ACT 14 in FIG. 5) and proceeds to ACT 15.

At ACT 15, the processor 101 controls the touch panel 104 to display a guide screen. The guide screen guides the store clerk or the customer to cause the bar code scanner 105 to read the payment bar code BCA. For example, the processor 101 controls the touch panel 104 to display a predetermined guide screen including a text message.

At ACT 16, the processor 101 waits until the payment bar code BCA is read. For example, when a bar code is read by the bar code scanner 105, the processor 101 determines whether the bar code represents a one-time code. When the bar code does not represent a one-time code, the processor 101 does not determine that the payment bar code BCA has been read (NO at ACT 16).

The store clerk or the customer operates the bar code scanner 105 to read the payment bar code BCA displayed on the bar code screen SCC. For example, when a bar code read by the bar code scanner 105 represents a one-time code, the processor 101 determines that the payment bar code BCA has been read or scanned (YES at ACT 16) and proceeds to ACT 17.

At ACT 17, the processor 101 acquires the one-time code and the additional data from bar code data obtained by reading the payment bar code BCA with the bar code scanner 105.

At ACT 18, the processor 101 requests the payment server 400 to make a payment. For example, the processor 101 controls the communication unit 111 to transmit predetermined request data for a payment request via the communication network 2 to the payment server 400. The processor 101 includes, in the request data to be transmitted, a payment amount related to a transaction registered at ACT 11 and the one-time code extracted at ACT 17. When the request data is transmitted via the communication network 2 to the payment server 400, the payment server 400 checks the validity of the one-time code included in the request data and when the one-time code is valid, performs a process to make a payment of the payment amount included in the request data. The payer of the payment made by this process is the customer using the user terminal 200. Here, this process for payment may be similar to an existing process for code payment. When the payment is completed, the payment server 400 transmits notification data via the communication network 2 to the POS terminal 100 to notify the completion of the payment.

After requesting the payment at ACT 18, the processor 101 proceeds to ACT 19.

At ACT 19, the processor 101 waits until the completion of the payment is notified. When the notification data is transmitted from the payment server 400 via the communication network 2 to the POS terminal 100 as described above and is received by the communication unit 111 (YES at ACT 19), the processor 101 proceeds to ACT 20.

At ACT 20, the processor 101 determines whether the additional data extracted at ACT 17 is setting data. When determining that the additional data is setting data (YES at ACT 20), the processor 101 proceeds to ACT 21.

At ACT 21, the processor 101 determines whether receipt issuance conditions determined based on the setting data are satisfied. For example, when the store, where the POS terminal 100 is being used, belongs to the category “restaurant”, the restaurant flag included in the setting data extracted at ACT 17 indicates that a receipt needs to be issued, and the number of items registered as transaction targets at ACT 11 is greater than or equal to the reference value in the setting data extracted at ACT 17, the processor 101 determines that receipt issuance conditions are satisfied. When determining that the receipt issuance conditions are satisfied (YES at ACT 21), the processor 101 proceeds to ACT 22.

At ACT 22, the processor 101 controls the receipt printer 110 to issue a receipt. For example, the processor 101 generates a receipt image that shows the contents of the transaction being processed in a predetermined format. Then, the processor 101 causes the receipt printer 110 to print the receipt image. After printing the receipt, the processor 101 ends the transaction process related to the transaction currently being processed.

When determining that the receipt issuance conditions determined based on the setting data are not satisfied (NO at ACT 21), the processor 101 skips ACT 22 and ends the transaction process. That is, the processor 101 does not issue a receipt when the receipt issuance conditions are not satisfied.

On the other hand, when determining that the additional data extracted at ACT 17 is not the setting data (NO at ACT 20), the processor 101 proceeds to ACT 23.

At ACT 23, the processor 101 determines whether the additional data extracted at ACT 17 is instruction data indicating an instruction to issue a receipt. When determining that the additional data is the instruction data indicating an instruction to issue a receipt (YES at ACT 23), the processor 101 proceeds to ACT 22. In other words, in this case, the processor 101 unconditionally issues a receipt.

When determining that the additional data acquired at ACT 17 is instruction data indicating an instruction to not issue a receipt (NO at ACT 23), the processor 101 skips ACT 22 and ends the transaction process. That is, the processor 101 does not issue a receipt regardless of the receipt issuance conditions.

Thus, the processor 101 performs a process according to settings indicated by the additional data that is represented by the payment bar code BCA.

After the bar code screen SCC is displayed at ACT 57 in FIG. 7, the processor 201 of the user terminal 200 proceeds to ACT 58.

At ACT 58, the processor 201 waits for an end instruction. At a given timing after causing the bar code scanner 105 to read the payment bar code BCA, the store clerk or the customer enters an end instruction by performing a predetermined operation such as tapping the button BUJ, . In response, the processor 201 determines that an end instruction has been entered (YES at ACT 58), and ends the code payment process.

As described above, in the transaction processing system 1, when code payment is performed, settings related to receipt issuance and set at the user terminal 200 are taken into the POS terminal 100 together with the one-time code, and receipt issuance at the POS terminal 100 is controlled according to the settings. This makes it possible to perform receipt issuance control at the POS terminal 100 according to needs of a payer that are represented by settings set in the user terminal 200.

Also, the POS terminal 100 obtains the settings related to receipt issuance control and set by the payer by reading the payment bar code BCA that is used by the POS terminal 100 to obtain the one-time code. This eliminates the need to perform a special operation to input the settings to the POS terminal 100. For example, the customer does not have to orally convey a request to a store clerk, and the store clerk does not have to perform an operation to input the request.

Also, in the transaction processing system 1, the POS terminal 100 determines whether receipt issuance conditions, which are determined based on setting data obtained from the user terminal 200, are satisfied and thereby determines whether to issue a receipt. This configuration makes it possible to flexibly perform receipt issuance control according to specific needs of payers, such as “receipts are necessary only for transactions at stores belonging to some categories” and “no receipt is necessary for a transaction of a small number of items”. Also, when receipt issuance control is performed based on setting data, the payer does not have to perform an operation to specify whether to issue a receipt for each payment.

Also, in the transaction processing system 1, when issuance or non-issuance of a receipt is set for each payment at the user terminal 200, the POS terminal 100 performs receipt issuance control according to the setting. Although it is necessary for the payer to perform an operation to specify issuance or non-issuance of a receipt, this configuration makes it possible to flexibly determine issuance or non-issuance of a receipt for each payment.

In the transaction processing system 1, when issuance or non-issuance of a receipt is not specified prior to payment, receipt issuance control is performed based on setting data. For example, this configuration enables the payer to normally use receipt issuance control based on setting data and to exceptionally determine whether to issue receipts for specific transactions and thereby makes it possible to flexibly control receipt issuance.

Various modifications may be made to the present embodiment as described below.

Although the issuance setting is set to “automatic” by default in the above embodiment, the issuance setting may be set to “issue” or “not issue” by default.

Although options “issue” and “not issue” are available for the issuance setting in the above embodiment, these options may be omitted, and bar code data represented by the payment bar code may always include setting data. Also, although the issuance setting can be set to “automatic” in the above embodiment, this option may be omitted, and bar code data represented by the payment bar code may include instruction data indicating “issue” or “not issue”. In this case, either “issue” or “not issue” maybe set as default; and a change instruction to change the default setting may be received for each transaction or a specification of “issue” or “not issue” maybe received for each transaction.

Only one of the condition related to the categories of stores and the condition related to the number of items in the above embodiment may be used as the condition for determining issuance or non-issuance of receipts. Alternatively, another condition may be used in place of one of the above conditions or in addition to the above conditions. For example, as another condition, a condition in which no receipt is issued when the payment amount is less than a predetermined amount may be used.

In addition to or in place of the settings related to issuance and non-issuance of receipts, data representing various settings made by respective payers may be included in bar code data represented by the payment bar code. For example, bar code data represented by the payment bar code may include a setting indicating whether a plastic bag is necessary, whether a formal receipt is necessary, or whether food is for eat-in or takeout. Also, bar code data represented by the payment bar code may include various settings related to requests of respective payers.

Furthermore, multiple types of settings may be included in bar code data represented by the same payment bar code.

The one-time code may be obtained by the user terminal 200 directly from the payment server 400.

Any authentication code other than the one-time code may also be used for authentication related to code payment.

Settings made by different payers may be managed by a server, such as the receipt server 300, the payment server 400, or any other server, and such a server may be configured to generate payment bar codes or generate data to be represented by payment bar codes.

The processor 201 of the user terminal 200 may be configured to determine whether to issue a receipt based on conditions and to include instruction data indicating whether to issue a receipt in the payment bar code based on the result of the determination.

In the above embodiment, the processor 201 performs a code payment process based on the user terminal program PRB, which is an application program for using an electronic receipt service, and uses a code payment service that is provided supplementarily as a part of the electronic receipt service. However, a code payment service provided independently of the electronic receipt service may also be used. In this case, the processor 201 performs the code payment process based on an application program that is different from the application program for using the electronic receipt service.

A part or the entirety of each of functions performed by the processors 101 and 201 may instead be performed by hardware, such as a logic circuit. Also, each of the functions may also be performed by a combination of hardware, such as a logic circuit, and software control.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A point-of-sale (POS) system, comprising:
a user terminal configured to generate and display a symbol that represents a payment code that can be used for payment in a sales transaction and a setting related to issuance of a receipt; and
a POS terminal including a scanner, a printer, and a processor configured to:
register one or more items for purchase,
decode a symbol read by the scanner to obtain a payment code and a setting,
execute payment processing for the items that have been registered for purchase using the payment code obtained by decoding the symbol,
after the payment processing is executed, determine whether to issue a receipt based on the setting obtained by decoding the symbol, and
upon determining to issue a receipt, control the printer to issue a receipt for the purchased items.

2. The POS system according to claim 1, wherein
the POS terminal includes a communication interface configured to communicate with a payment server, and
the processor is configured to, when executing the payment processing, control the communication interface to transmit to the payment server a request for payment with the payment code.

3. The POS system according to claim 1, wherein
the setting indicates whether a receipt is to be issued for each of predetermined categories of sales transactions, and
the processor is configured to:
determine a category of a current sales transaction, and
determine to issue a receipt when the setting indicates that a receipt is to be issued for the category of the current sales transaction.

4. The POS system according to claim 3, wherein the predetermined categories include restaurants, grocery stores, convenience stores, and clothing stores.

5. The POS system according to claim 1, wherein
the setting indicates a reference value,
the processor is configured to determine a number of the registered items, and
the processor determines to issue a receipt when the number of the registered items exceeds the reference value.

6. The POS system according to claim 1, wherein the user terminal is configured to display a first screen that includes:
a first object for starting payment processing using the payment code, and
a second object for selecting whether to issue a receipt after payment processing and for modifying the setting.

7. The POS system according to claim 6, wherein the user terminal is configured to display, after the second object is operated to modify the setting, a second screen through which the setting can be modified.

8. The POS system according to claim 6, wherein the user terminal is configured to, after the first object is operated:
acquire the payment code from a receipt server,
generate the symbol based on the acquired payment code and the setting, and
display a third screen including the generated symbol.

9. A method performed by a point-of-sale (POS) system, the method comprising:
registering one or more items for purchase in a sales transaction;
generating and displaying a symbol that represents a payment code that can be used for payment in the sales transaction and a setting related to issuance of a receipt;
scanning the symbol by a scanner;
decoding the symbol and acquiring the payment code and the setting from the symbol;
executing payment processing for the registered items using the payment code;
after the payment processing is executed, determining whether to issue a receipt based on the setting; and
after determining to issue a receipt, issuing a receipt for the purchased items.

10. The method according to claim 9, further comprising:
in the payment processing, transmitting to a payment server a request for payment with the payment code.

11. The method according to claim 9, wherein
the setting indicates whether a receipt is to be issued for each of predetermined categories of sales transactions,
the method further comprises:
determining a category of a current sales transaction, and
the receipt is issued when the setting indicates that a receipt is to be issued for the category of the current sales transaction.

12. The method according to claim 11, wherein the predetermined categories include restaurants, grocery stores, convenience stores, and clothing stores.

13. The method according to claim 9, wherein
the setting indicates a reference value,
the method further comprises:
determining a number of the registered items, and
the receipt is issued when the number of the registered items exceeds the reference value.

14. The method according to claim 9, further comprising:
before displaying the symbol, displaying a first screen that includes:
a first object for starting payment processing using the payment code, and
a second object for selecting whether to issue a receipt after payment
processing and for modifying the setting.

15. The method according to claim 14, further comprising:
displaying, after the second object is operated to modify the setting, a second screen through which the setting can be modified.

16. The method according to claim 14, further comprising:
after the first object is operated, acquiring the payment code from a receipt server.

17. A user terminal used in a point-of-sale (POS) system, comprising:
a display; and
a processor configured to:
acquire a payment code that can be used for payment in a sales transaction,
acquire a setting related to issuance of a receipt in the sales transaction,
encode the payment code and the setting into a symbol, and
control the display to display the symbol, wherein
the symbol causes a POS terminal of the POS system to execute payment processing using the payment code and determine to issue a receipt based on the setting.

18. The user terminal according to claim 17, wherein the processor is configured to control the display to display a first screen that includes:
a first object for starting payment processing using the payment code, and
a second object for selecting whether to issue a receipt after payment processing and for modifying the setting.

19. The user terminal according to claim 18, wherein the processor is configured to, after the second object is operated to modify the setting, control the display to display a second screen through which the setting can be modified.

20. The user terminal according to claim 18, wherein the processor is configured to, after the first object is operated, acquire the payment code from a receipt server.
